(19) United States
(12) Patent Application Publication
(10) Pub. No.: US 2023/0078197 A1
(43) Pub. Date: Mar. 16, 2023

(54) ENFORCING DATA SOVEREIGNTY POLICIES FOR OBJECT-BASED STORAGE

(71) Applicant: Cisco Technology, Inc., San Jose, CA (US)

(72) Inventors: Robert E. Barton, Richmond (CA); Jerome Henry, Pittsboro, NC (US); Vinay Saini, Bangalore (IN); David John Zacks, Vancouver (CA); Carlos M. Pignataro, Cary, NC (US); Nagendra Kumar Nainar, Morrisville, NC (US)

(21) Appl. No.: 17/477,036

(22) Filed: Sep. 16, 2021

(51) Int. Cl. G06F 21/62; G06F 21/31; G06F 21/78; G06F 21/60

(52) U.S. Cl. CPC G06F 21/6245; G06F 21/31; G06F 21/78; G06F 21/604

(57) ABSTRACT

In one example, a controller obtains a request to store an object-based storage object and identifies a data sovereignty policy identifier associated with the object-based storage object. The controller queries a data sovereignty policy manager for a data sovereignty policy associated with the data sovereignty policy identifier and obtains, from the data sovereignty policy manager, an indication of the data sovereignty policy. The controller stores the object-based storage object in compliance with the data sovereignty policy.

### TECHNICAL FIELD

The present disclosure relates to computer networking.

### BACKGROUND

“Data sovereignty” refers to a concept whereby an entity can control where and/or how data is stored. The entity may be a government, a private company, etc. The data may include Personally Identifiable Information (PII) data (e.g., personal health records), federal government departmental data, confidential company data, etc.

### BRIEF DESCRIPTION OF THE DRAWINGS

FIG. 1 illustrates a system configured to enforce data sovereignty policies for object-based storage, according to an example embodiment.

FIG. 2 illustrates a block diagram of an object-based storage object, according to an example embodiment.

FIG. 3 illustrates a flowchart of a method for enforcing data sovereignty policies for object-based storage, according to an example embodiment.

FIG. 4 illustrates a hardware block diagram of a computing device configured to perform functions associated with operations discussed herein, according to an example embodiment.

FIG. 5 illustrates a flowchart of a method for performing functions associated with operations discussed herein, according to an example embodiment.

### DESCRIPTION OF EXAMPLE EMBODIMENTS

### Overview

Techniques are provided herein for enforcing data sovereignty policies for object-based storage. In one example embodiment, a controller obtains a request to store an object-based storage object and identifies a data sovereignty policy identifier associated with the object-based storage object. The controller queries a data sovereignty policy manager for a data sovereignty policy associated with the data sovereignty policy identifier and obtains, from the data sovereignty policy manager, an indication of the data sovereignty policy. The controller stores the object-based storage object in compliance with the data sovereignty policy.

### Example Embodiments

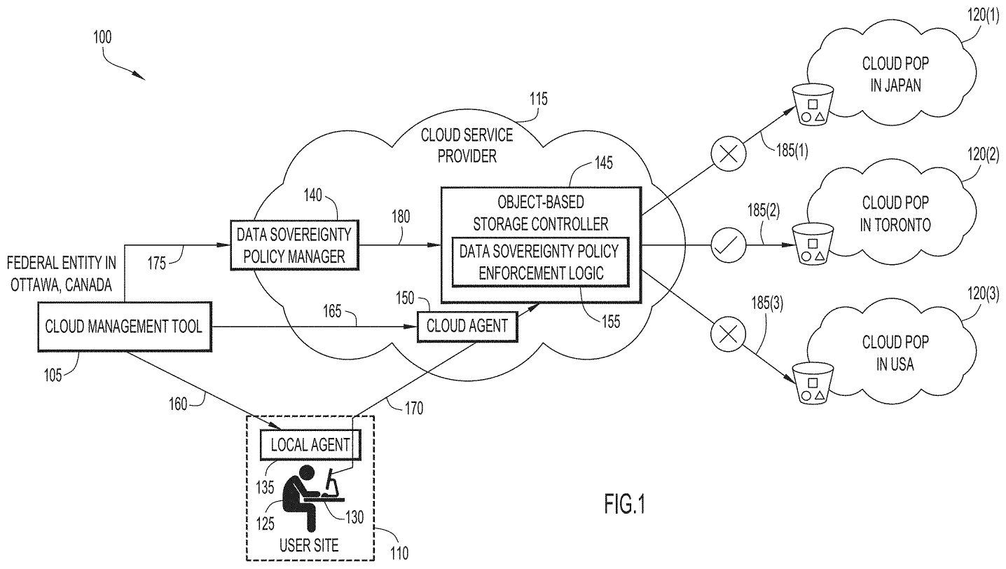

FIG. 1 illustrates an example system 100 configured to enforce data sovereignty policies for object-based storage. System 100 includes cloud management tool 105, user site 110, cloud service provider 115, and cloud Points-of-Presence (PoPs) 120(1)-120(3). User site 110 may include user device 130 and local agent 135. Cloud service provider 115 may include data sovereignty policy manager 140, object-based storage controller 145, and cloud agent 150.

Cloud management tool 105 may be one of many modules in a centralized console that permits an entity to manage cloud-related tasks via a user interface. In this example, the entity may be a federal/governmental entity in Ottawa, Canada that uses cloud service provider 115 for a variety of workloads and storage. User 125 may be an employee of the federal entity, and user site 110 may be a physical space such as an office or a building. If user device 130 is portable (e.g., a laptop), user site 110 may be the physical space proximate to the location of user device 130 at any given time. As shown, cloud service provider 115 may offer data storage options in Japan (cloud PoP 120(1)); Toronto, Canada (cloud PoP 120(2)); and the United States of America (USA) (cloud PoP 120(3)). The federal entity may want certain data generated by user 125 to be stored only in Canada.

Often, an agreement between an organization and a cloud service provider will specify that all applications and data storage under the agreement must meet federal data sovereignty rules/laws by storing sensitive data within the physical borders of the applicable country. Today, many countries, states, and provinces are adopting ever-stricter data sovereignty laws. As applications continue to rapidly migrate to cloud-based services, conventional approaches cannot adequately guarantee that data adheres to data sovereignty rules. Conventional approaches struggle particularly with large cloud service providers that support data centers in multiple locations throughout the world.

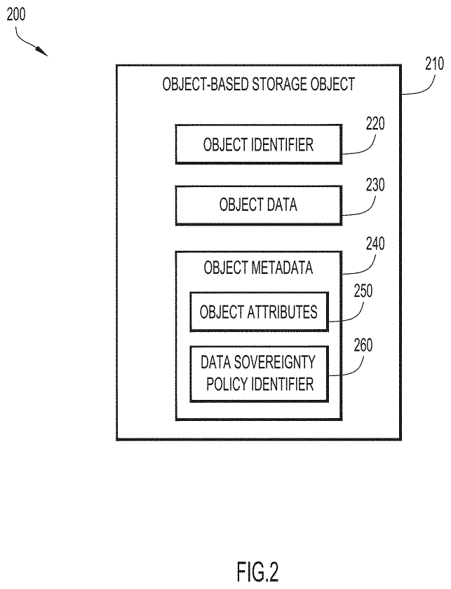

Accordingly, techniques are described herein for reliably enforcing data sovereignty policies. The techniques described herein may use object-based storage, which allows a flexible amount of metadata and attributes to be attached to an object-based storage object. Object-based storage will be discussed in greater detail below with reference to FIG. 2.

With reference to FIG. 1, object-based storage controller 145 is configured with data sovereignty policy enforcement logic 155 to cause object-based storage controller 145 to perform operations described herein with respect to enforcing data sovereignty policies for object-based storage.

In one example, a network administrator of the federal entity may use cloud management tool 105 to define/create/dictate a custom (e.g., unique/per-entity) data sovereignty policy indicating that a given type of data is to be stored in one or more given geographic regions. The data sovereignty policy may control which geographical data centers can store certain data generated by user 125, and under what conditions. For example, the data sovereignty policy may indicate that confidential government data generated by user 125 is to be stored in Canada. The data sovereignty policy may include details relating to certain highly-sensitive applications or types of applications, and where data obtained from those applications may be stored.

Cloud management tool 105 may also obtain an indication of a data sovereignty policy identifier. The data sovereignty policy identifier may be any suitable identifier, such as a machine- or human-readable string of characters/symbols. The data sovereignty policy identifier may be manually or automatically generated. In one example, the network administrator of the federal entity may manually input the data sovereignty policy identifier. In another example, cloud management tool 105 may automatically generate the data sovereignty policy identifier. The data sovereignty policy identifier may uniquely identify the data sovereignty policy for the federal entity.

Cloud management tool 105 may provide an indication of the data sovereignty policy identifier to one or more data sovereignty policy enforcement agents. As represented by arrow 160, cloud management tool 105 may provide the data sovereignty policy identifier to a data sovereignty policy enforcement agent located within user site 110, such as local agent 135. For example, local agent 135 may be located on user device 130 or on a suitable network device in user site 110. As represented by arrow 165, cloud management tool 105 may provide the data sovereignty policy identifier to a data sovereignty policy enforcement agent outside user site 110, such as cloud agent 150. For example, cloud agent 150 may be located on a server in a network of cloud service provider 115.

Cloud management tool 105 may also provide, to local agent 135 and/or cloud agent 150, instructions to write the data sovereignty policy identifier to certain requests sent from user device 130 to object-based storage controller 145. The requests, which are represented by arrow 170, may include a request to store an object-based storage object. These requests will be discussed in greater detail below.

As represented by arrow 175, cloud management tool 105 may provide, to data sovereignty policy manager 140, an indication of the data sovereignty policy identifier and the corresponding data sovereignty policy. Cloud management tool 105 may provide this indication to the data sovereignty policy manager 140 before, while, or after providing, to local agent 135 and/or cloud agent 150, the indication of the data sovereignty policy identifier and/or the indication to write the data sovereignty policy identifier to the requests sent from user device 130 to object-based storage controller 145.

At this stage, local agent 135 and cloud agent 150 have obtained the data sovereignty policy identifier and instructions to write the data sovereignty policy identifier to certain requests sent from user device 130 to object-based storage controller 145, and data sovereignty policy manager 140 has obtained an indication of the data sovereignty policy identifier and the corresponding data sovereignty policy.

As represented by arrow 170, user device 130 may send to object-based storage controller 145, a request to store an object-based storage object. User 125 may prompt user device 130 to send the request; additionally/alternatively, the request may be sent by an application. Local agent 135 and/or cloud agent 150 may intercept the request and write (e.g., augment, encode, etc.) the data sovereignty policy identifier to the request. In one example, if the request is sent from an application on the desktop of user device 130 (e.g., a word processing application), the data sovereignty policy identifier may be written by local agent 135. In another example, if the request is sent from an application on the cloud (e.g., a Security-as-a-Service application), the data sovereignty policy identifier may be written by cloud agent 150. The data sovereignty policy identifier may be written to the request by any suitably situated data sovereignty policy enforcement agent (e.g., an agent that sits between user device 130 and object-based storage controller 145).

In one example, the request may be in the form of a Hypertext Transfer Protocol (HTTP) Application Programming Interface (API) call from user device 130 to object-based storage controller 145. Local agent 135 and/or cloud agent 150 may write to object-based storage controller 145 by adding one or more fields to the API call that indicate the data sovereignty policy identifier. Local agent 135 and/or cloud agent 150 may sit low enough in the application stack that local agent 135 and/or cloud agent 150 can monitor the application space and examine procedure calls. Local agent 135 and/or cloud agent 150 may have complete (or near-complete) visibility into a given application/API, and may identify which application(s) is/are running and which devices or actors are communicating through APIs.

In one example, object-based storage controller 145 obtains, from user device 130, the request to store an object-based storage object, and identifies the data sovereignty policy identifier associated with the object-based storage object. As represented by arrow 180, object-based storage controller 145 queries data sovereignty policy manager 140 for a data sovereignty policy associated with the data sovereignty policy identifier. Data sovereignty policy manager 140 may receive the query and identify the corresponding data sovereignty policy. In one example, the data sovereignty policy identifier and the data sovereignty policy may be indexed in data sovereignty policy manager 140 by the specific fields used by local agent 135 and/or cloud agent 150 to identify the data sovereignty policy identifier in the API call.

As further represented by arrow 180, object-based storage controller 145 may obtain, from data sovereignty policy manager 140, an indication of the data sovereignty policy. Object-based storage controller 145 may store the object-based storage object in compliance with the data sovereignty policy. In this example, the data sovereignty policy permits object-based storage controller 145 to write the object-based storage object to cloud PoP 120(2) (Toronto, Canada), but not cloud PoP 120(1) (Japan) or cloud PoP 120(3) (USA). As represented by arrows 185(1), 185(2) and 185(3), object-based storage controller 145 writes the object-based storage object to cloud PoP 120(2) (Toronto, Canada), and not to cloud PoP 120(1) (Japan) or cloud PoP 120(3) (USA).

In one example, object-based storage controller 145 may store the object-based storage object with the data sovereignty policy identifier. For instance, object-based storage controller 145 may store the data sovereignty policy identifier in metadata of the object-based storage object. Thus, the metadata attached to the object-based storage object may include an indication of the data sovereignty requirements (in the form of the data sovereignty policy identifier) for that object-based storage object.

Based on the data sovereignty policy identifier, object-based storage controller 145 may perform an audit to determine whether the object-based storage object is stored in compliance with the data sovereignty policy. Object-based storage controller 145 may perform the audit automatically or in response to a demand by the entity. In one example, object-based storage controller 145 may generate a human-readable report of the audit. The human-readable report may indicate where the object-based storage object (and, optionally, other object-based storage objects associated with the entity) are stored. A network administrator of the entity may review the human-readable report to verify that the object-based storage object(s) is/are stored in compliance with the data sovereignty policy/policies.

In one example, object-based storage controller 145 may train an Artificial Intelligence (AI)/Machine Learning (ML) model based on the data sovereignty policies, associated entities, data sources (e.g., specific users/applications), etc. Object-based storage controller 145 may train the AI/ML model to output suggested data sovereignty policies for a given entity or API call, for example. The AI/ML model may be trained online or offline at any suitable location within or outside system 100, such as at one or more servers hosting object-based storage controller 145 or any other server(s).

With continuing reference to FIG. 1, FIG. 2 illustrates an example block diagram 200 of an object-based storage object 210. Object-based storage object 210 may, for example, be stored in a data center in Toronto by object-based storage controller 145. Object-based storage object 210 includes object identifier 220, object data 230, and object metadata 240. Object identifier 220 may be any suitable identifier that uniquely identifies object-based storage object 210. Object data 230 may be subject to a data sovereignty policy that controls where object data 230 can be physically stored. Object metadata 240 includes any suitable information that characterizes object-based storage object 210, including object attributes 250 and/or data sovereignty policy identifier 260. Object metadata 240 may include details that provide context for object data 230, such as country/state/province of origin, the segment size (e.g., the size of the part of the file that is stored on a given server), the link to a file descriptor (which may be on another server), the number of segments in the overall files (which may depend on the size of the chunks in which the file was sliced), the origin of the segment (e.g., where the segment was written from), etc. Object attributes 250 may include one or more properties of object-based storage object 210, such as type (e.g., a text file), encoding (e.g., UTF), owner, rights (e.g., 755), etc. It will be appreciated that data sovereignty policy identifier 260 may be stored in any suitable hierarchy or arrangement, such as in object metadata 240 and/or object attributes 250.

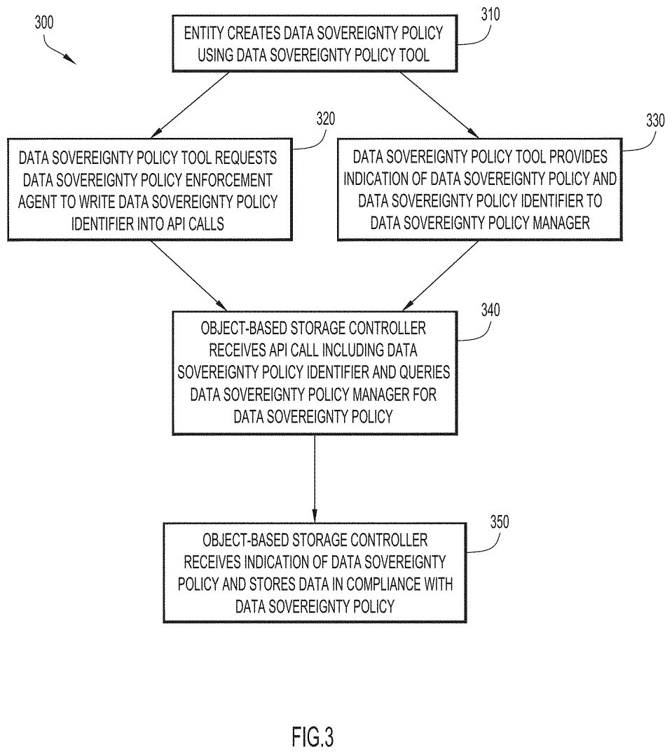

FIG. 3 illustrates a flowchart of an example method 300 for enforcing data sovereignty policies for object-based storage. At operation 310, an entity creates/defines a data sovereignty policy using a data sovereignty policy tool. The data sovereignty policy tool may enable any suitable number of entities to define unique data sovereignty policies on a per-entity basis. The entities may include federal and/or private entities. If the entities are using a collection of cloud service providers to store data, the data sovereignty policy tool may enable the entities to specify data sovereignty policies for multiple cloud service providers.

The data sovereignty policy tool may allow an entity to dictate that all data generated from specific networks, departments, and/or applications must adhere to a given data sovereignty policy by storing that data in a given country, province, etc. The data sovereignty policies may be based on any suitable factor(s), such as the location of the user, the department or group to which the user belongs, etc. The data sovereignty policies may be flexible and adaptable for different hierarchies and situations to define how and where data is stored. In the public sector, entities may be required to adhere to applicable federal, provincial, and state data sovereignty policies. The specific data sovereignty policies may differ for each region and/or industry, and as a result, the entities may define data sovereignty policies that match data sovereignty rules for the corresponding region/country.

In one example, health care may have different data sovereignty policies than other verticals. As a result, a health care system might define a policy where all medical patient health care records can be stored only in a cloud system within the applicable country, state, or province, but other data that does not involve patient records may be stored anywhere. Or the health care system might define a rule that all data of a certain type (e.g., data originating from a medical application) can only be stored in-country.

At operation 320, the data sovereignty policy tool requests a data sovereignty policy enforcement agent to write, to one or more API calls from a user device to an object-based storage controller, a data sovereignty policy identifier associated with the data sovereignty policy. The data sovereignty policy identifier may indicate a level of control required for certain data and/or where the data can be stored. The data sovereignty policy identifier may be an identifying mark that can be used to orchestrate/enforce a corresponding data sovereignty policy (e.g., a cloud data sovereignty policy).

At operation 330, the data sovereignty policy tool provides an indication of the data sovereignty policy and the corresponding data sovereignty policy identifier to a data sovereignty policy manager. Operation 330 may occur before, during, or after operation 320.

At operation 340, the object-based storage controller receives, from a user device, an API call that requests the object-based storage controller to store an object-based storage object. The API call includes the data sovereignty policy identifier. The data sovereignty policy enforcement agent may have augmented the API call en route to the object-based storage controller with the data sovereignty policy identifier. For example, if the data originated from a medical application, then the data sovereignty policy enforcement agent may add a field in the API call indicating that the data is extremely sensitive. In response to receiving the API call, the object-based storage controller queries the data sovereignty policy manager for the data sovereignty policy.

At operation 350, the object-based storage controller may receive, from the data sovereignty policy manager, an indication of the data sovereignty policy. The data sovereignty policy manager may feed instructions to the object-based storage controller for how to handle each of the different requests to write data from the user device (e.g., client/application). Thus, the object-based storage controller may check the data sovereignty policy before attempting to store the object-based storage object (or parts of the object-based storage object). This may ensure that only data centers that have geographical compliance (or other types of compliance) with the data sovereignty policy are used to store the data; physical sites that do not comply may not be used. Therefore, the object-based storage controller may store data in compliance with the data sovereignty policy. The object-based storage object and metadata/attributes may be stored in any suitable location. The object-based storage controller may prevent any sensitive data from being stored in a place that violates the data sovereignty policy.

In a further example, the object-based storage controller may write, to the object metadata, details identifying the data sovereignty (e.g., PII requirements) of the data. For example, when the object-based storage controller writes the data to storage as an object-based storage object, the object-based storage controller may encode region-specific data sovereignty information for the object-based storage object directly into metadata of the object-based storage object. As a result, the data stored in the cloud may include a data sovereignty policy identifier that can be used to enforce various data sovereignty policies, comply with government data sovereignty laws, and audit data storage. For example, the data sovereignty policy identifier in the metadata may control whether data can be stored in a given remote site in compliance with the data sovereignty policy. The cloud service provider may examine the metadata (e.g., data sovereignty policy identifier) to ensure the data sovereignty policies are being upheld and/or in preparation for moving the data within the cloud network.

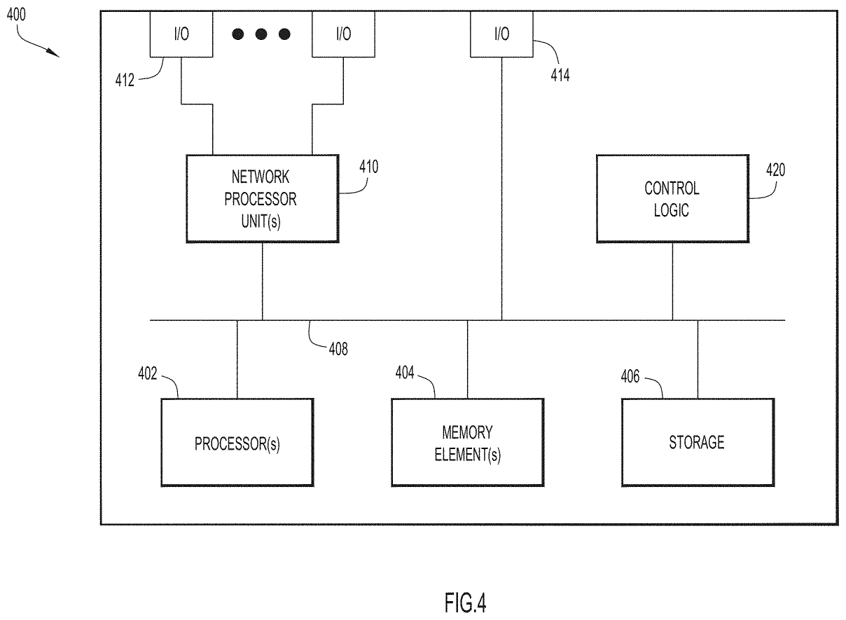

Referring to FIG. 4, FIG. 4 illustrates a hardware block diagram of a computing device 400 that may perform functions associated with operations discussed herein in connection with the techniques depicted in FIGS. 1-3. In various embodiments, a computing device, such as computing device 400 or any combination of computing devices 400, may be configured as any entity/entities as discussed for the techniques depicted in connection with FIGS. 1-3 in order to perform operations of the various techniques discussed herein.

In at least one embodiment, computing device 400 may include one or more processor(s) 402, one or more memory element(s) 404, storage 406, a bus 408, one or more network processor unit(s) 410 interconnected with one or more network input/output (I/O) interface(s) 412, one or more I/O interface(s) 414, and control logic 420. In various embodiments, instructions associated with logic for computing device 400 can overlap in any manner and are not limited to the specific allocation of instructions and/or operations described herein.

In at least one embodiment, processor(s) 402 is/are at least one hardware processor configured to execute various tasks, operations and/or functions for computing device 400 as described herein according to software and/or instructions configured for computing device 400. Processor(s) 402 (e.g., a hardware processor) can execute any type of instructions associated with data to achieve the operations detailed herein. In one example, processor(s) 402 can transform an element or an article (e.g., data, information) from one state or thing to another state or thing. Any of potential processing elements, microprocessors, digital signal processor, baseband signal processor, modem, PHY, controllers, systems, managers, logic, and/or machines described herein can be construed as being encompassed within the broad term ‘processor.’

In at least one embodiment, memory element(s) 404 and/or storage 406 is/are configured to store data, information, software, and/or instructions associated with computing device 400, and/or logic configured for memory element(s) 404 and/or storage 406. For example, any logic described herein (e.g., control logic 420) can, in various embodiments, be stored for computing device 400 using any combination of memory element(s) 404 and/or storage 406. Note that in some embodiments, storage 406 can be consolidated with memory elements 404 (or vice versa), or can overlap/exist in any other suitable manner.

In at least one embodiment, bus 408 can be configured as an interface that enables one or more elements of computing device 400 to communicate in order to exchange information and/or data. Bus 408 can be implemented with any architecture designed for passing control, data and/or information between processors, memory elements/storage, peripheral devices, and/or any other hardware and/or software components that may be configured for computing device 400. In at least one embodiment, bus 408 may be implemented as a fast kernel-hosted interconnect, potentially using shared memory between processes (e.g., logic), which can enable efficient communication paths between the processes.

In various embodiments, network processor unit(s) 410 may enable communication between computing device 400 and other systems, entities, etc., via network I/O interface(s) 412 to facilitate operations discussed for various embodiments described herein. In various embodiments, network processor unit(s) 410 can be configured as a combination of hardware and/or software, such as one or more Ethernet driver(s) and/or controller(s) or interface cards, Fibre Channel (e.g., optical) driver(s) and/or controller(s), and/or other similar network interface driver(s) and/or controller(s) now known or hereafter developed to enable communications between computing device 400 and other systems, entities, etc. to facilitate operations for various embodiments described herein. In various embodiments, network I/O interface(s) 412 can be configured as one or more Ethernet port(s), Fibre Channel ports, and/or any other I/O port(s) now known or hereafter developed. Thus, the network processor unit(s) 410 and/or network I/O interfaces 412 may include suitable interfaces for receiving, transmitting, and/or otherwise communicating data and/or information in a network environment.

I/O interface(s) 414 allow for input and output of data and/or information with other entities that may be connected to computing device 400. For example, I/O interface(s) 414 may provide a connection to external devices such as a keyboard, keypad, a touch screen, and/or any other suitable input device now known or hereafter developed. In some instances, external devices can also include portable computer readable (non-transitory) storage media such as database systems, thumb drives, portable optical or magnetic disks, and memory cards. In still some instances, external devices can be a mechanism to display data to a user, such as, for example, a computer monitor, a display screen, or the like.

In various embodiments, control logic 420 can include instructions that, when executed, cause processor(s) 402 to perform operations, which can include, but not be limited to, providing overall control operations of computing device 400; interacting with other entities, systems, etc. described herein; maintaining and/or interacting with stored data, information, parameters, etc. (e.g., memory element(s), storage, data structures, databases, tables, etc.); combinations thereof; and/or the like to facilitate various operations for embodiments described herein.

The programs described herein (e.g., control logic 420) may be identified based upon application(s) for which they are implemented in a specific embodiment. However, it should be appreciated that any particular program nomenclature herein is used merely for convenience; thus, embodiments herein should not be limited to use(s) solely described in any specific application(s) identified and/or implied by such nomenclature.

In various embodiments, entities as described herein may store data/information in any suitable volatile and/or non-volatile memory item (e.g., magnetic hard disk drive, solid state hard drive, semiconductor storage device, Random Access Memory (RAM), Read Only Memory (ROM), Erasable Programmable ROM (EPROM), Application Specific Integrated Circuit (ASIC), etc.), software, logic (fixed logic, hardware logic, programmable logic, analog logic, digital logic), hardware, and/or in any other suitable component, device, element, and/or object as may be appropriate. Any of the memory items discussed herein should be construed as being encompassed within the broad term ‘memory element’. Data/information being tracked and/or sent to one or more entities as discussed herein could be provided in any database, table, register, list, cache, storage, and/or storage structure: all of which can be referenced at any suitable timeframe. Any such storage options may also be included within the broad term ‘memory element’ as used herein.

Note that in certain example implementations, operations as set forth herein may be implemented by logic encoded in one or more tangible media that is capable of storing instructions and/or digital information and may be inclusive of non-transitory tangible media and/or non-transitory computer readable storage media (e.g., embedded logic provided in: an ASIC, Digital Signal Processing (DSP) instructions, software [potentially inclusive of object code and source code], etc.) for execution by one or more processor(s), and/or other similar machine, etc. Generally, memory element(s) 404 and/or storage 406 can store data, software, code, instructions (e.g., processor instructions), logic, parameters, combinations thereof, and/or the like used for operations described herein. This includes memory elements 404 and/or storage 406 being able to store data, software, code, instructions (e.g., processor instructions), logic, parameters, combinations thereof, or the like that are executed to carry out operations in accordance with teachings of the present disclosure.

In some instances, software of the present embodiments may be available via a non-transitory computer useable medium (e.g., magnetic or optical mediums, magneto-optic mediums, Compact Disc ROM (CD-ROM), Digital Versatile Disc (DVD), memory devices, etc.) of a stationary or portable program product apparatus, downloadable file(s), file wrapper(s), object(s), package(s), container(s), and/or the like. In some instances, non-transitory computer readable storage media may also be removable. For example, a removable hard drive may be used for memory/storage in some implementations. Other examples may include optical and magnetic disks, thumb drives, and smart cards that can be inserted and/or otherwise connected to computing device 400 for transfer onto another computer readable storage medium.

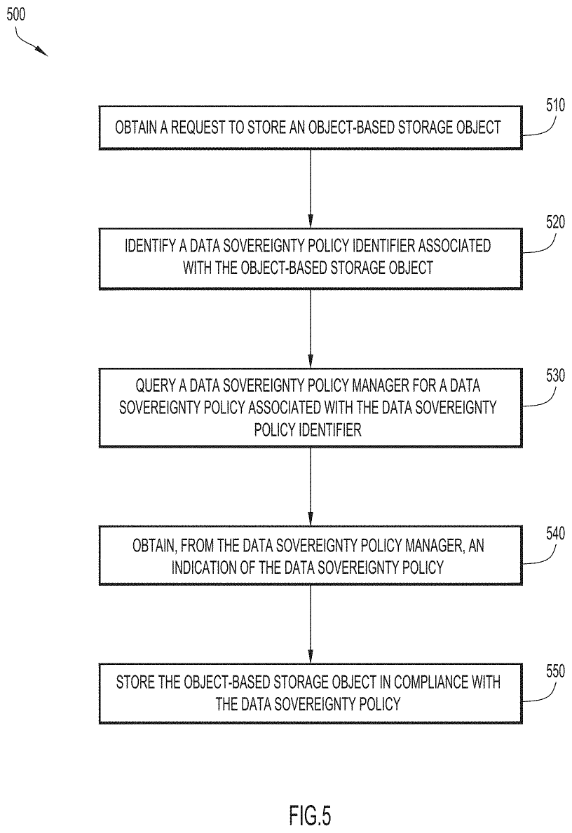

FIG. 5 is a flowchart of an example method 500 for performing functions associated with operations discussed herein. Reference is also made to FIG. 1 for purposes of the description of FIG. 5. Method 500 may be a computer-implemented method performed by any suitable network entity, such as object-based storage controller 145 or computing device 400. At operation 510, object-based storage controller 145 obtains a request to store an object-based storage object. At operation 520, object-based storage controller 145 identifies a data sovereignty policy identifier associated with the object-based storage object. At operation 530, object-based storage controller 145 queries a data sovereignty policy manager for a data sovereignty policy associated with the data sovereignty policy identifier. At operation 540, object-based storage controller 145 obtains, from the data sovereignty policy manager, an indication of the data sovereignty policy. At operation 550, object-based storage controller 145 stores the object-based storage object in compliance with the data sovereignty policy.

Embodiments described herein may include one or more networks, which can represent a series of points and/or network elements of interconnected communication paths for receiving and/or transmitting messages (e.g., packets of information) that propagate through the one or more networks. These network elements offer communicative interfaces that facilitate communications between the network elements. A network can include any number of hardware and/or software elements coupled to (and in communication with) each other through a communication medium. Such networks can include, but are not limited to, any Local Area Network (LAN), Virtual LAN (VLAN), Wide Area Network (WAN) (e.g., the Internet), Software Defined WAN (SD-WAN), Wireless Local Area (WLA) access network, Wireless Wide Area (WWA) access network, Metropolitan Area Network (MAN), Intranet, Extranet, Virtual Private Network (VPN), Low Power Network (LPN), Low Power Wide Area Network (LPWAN), Machine to Machine (M2M) network, Internet of Things (IoT) network, Ethernet network/switching system, any other appropriate architecture and/or system that facilitates communications in a network environment, and/or any suitable combination thereof.

Networks through which communications propagate can use any suitable technologies for communications including wireless communications (e.g., 4G/5G/nG, IEEE 802.11 (e.g., Wi-Fi®/Wi-Fib®), IEEE 802.16 (e.g., Worldwide Interoperability for Microwave Access (WiMAX)), Radio-Frequency Identification (RFID), Near Field Communication (NFC), Bluetooth™, mm.wave, Ultra-Wideband (UWB), etc.), and/or wired communications (e.g., T1 lines, T3 lines, digital subscriber lines (DSL), Ethernet, Fibre Channel, etc.). Generally, any suitable means of communications may be used such as electric, sound, light, infrared, and/or radio to facilitate communications through one or more networks in accordance with embodiments herein. Communications, interactions, operations, etc. as discussed for various embodiments described herein may be performed among entities that may be directly or indirectly connected utilizing any algorithms, communication protocols, interfaces, etc. (proprietary and/or non-proprietary) that allow for the exchange of data and/or information.

In various example implementations, entities for various embodiments described herein can encompass network elements (which can include virtualized network elements, functions, etc.) such as, for example, network appliances, forwarders, routers, servers, switches, gateways, bridges, load-balancers, firewalls, processors, modules, radio receivers/transmitters, or any other suitable device, component, element, or object operable to exchange information that facilitates or otherwise helps to facilitate various operations in a network environment as described for various embodiments herein. Note that with the examples provided herein, interaction may be described in terms of one, two, three, or four entities. However, this has been done for purposes of clarity, simplicity and example only. The examples provided should not limit the scope or inhibit the broad teachings of systems, networks, etc. described herein as potentially applied to a myriad of other architectures.

Communications in a network environment can be referred to herein as ‘messages’, ‘messaging’, ‘signaling’, ‘data’, ‘content’, ‘objects’, ‘requests’, ‘queries’, ‘responses’, ‘replies’, etc. which may be inclusive of packets. As referred to herein and in the claims, the term ‘packet’ may be used in a generic sense to include packets, frames, segments, datagrams, and/or any other generic units that may be used to transmit communications in a network environment. Generally, a packet is a formatted unit of data that can contain control or routing information (e.g., source and destination address, source and destination port, etc.) and data, which is also sometimes referred to as a ‘payload’, ‘data payload’, and variations thereof. In some embodiments, control or routing information, management information, or the like can be included in packet fields, such as within header(s) and/or trailer(s) of packets. Internet Protocol (IP) addresses discussed herein and in the claims can include any IP version 4 (IPv4) and/or IP version 6 (IPv6) addresses.

To the extent that embodiments presented herein relate to the storage of data, the embodiments may employ any number of any conventional or other databases, data stores or storage structures (e.g., files, databases, data structures, data or other repositories, etc.) to store information.

Note that in this Specification, references to various features (e.g., elements, structures, nodes, modules, components, engines, logic, steps, operations, functions, characteristics, etc.) included in ‘one embodiment’, ‘example embodiment’, ‘an embodiment’, ‘another embodiment’, ‘certain embodiments’, ‘some embodiments’, ‘various embodiments’, ‘other embodiments’, ‘alternative embodiment’, and the like are intended to mean that any such features are included in one or more embodiments of the present disclosure, but may or may not necessarily be combined in the same embodiments. Note also that a module, engine, client, controller, function, logic or the like as used herein in this Specification, can be inclusive of an executable file comprising instructions that can be understood and processed on a server, computer, processor, machine, compute node, combinations thereof, or the like and may further include library modules loaded during execution, object files, system files, hardware logic, software logic, or any other executable modules.

It is also noted that the operations and steps described with reference to the preceding figures illustrate only some of the possible scenarios that may be executed by one or more entities discussed herein. Some of these operations may be deleted or removed where appropriate, or these steps may be modified or changed considerably without departing from the scope of the presented concepts. In addition, the timing and sequence of these operations may be altered considerably and still achieve the results taught in this disclosure. The preceding operational flows have been offered for purposes of example and discussion. Substantial flexibility is provided by the embodiments in that any suitable arrangements, chronologies, configurations, and timing mechanisms may be provided without departing from the teachings of the discussed concepts.

As used herein, unless expressly stated to the contrary, use of the phrase ‘at least one of’, ‘one or more of’, ‘and/or’, variations thereof, or the like are open-ended expressions that are both conjunctive and disjunctive in operation for any and all possible combination of the associated listed items. For example, each of the expressions ‘at least one of X, Y and Z’, ‘at least one of X, Y or Z’, ‘one or more of X, Y and Z’, ‘one or more of X, Y or Z’ and ‘X, Y and/or Z’ can mean any of the following: 1) X, but not Y and not Z; 2) Y, but not X and not Z; 3) Z, but not X and not Y; 4) X and Y, but not Z; 5) X and Z, but not Y; 6) Y and Z, but not X; or 7) X, Y, and Z.

Additionally, unless expressly stated to the contrary, the terms ‘first’, ‘second’, ‘third’, etc., are intended to distinguish the particular nouns they modify (e.g., element, condition, node, module, activity, operation, etc.). Unless expressly stated to the contrary, the use of these terms is not intended to indicate any type of order, rank, importance, temporal sequence, or hierarchy of the modified noun. For example, ‘first X’ and ‘second X’ are intended to designate two ‘X’ elements that are not necessarily limited by any order, rank, importance, temporal sequence, or hierarchy of the two elements. Further as referred to herein, ‘at least one of’ and ‘one or more of can be represented using the’(s)′ nomenclature (e.g., one or more element(s)).

In one form, a computer-implemented method is provided. The method comprises: obtaining a request to store an object-based storage object; identifying a data sovereignty policy identifier associated with the object-based storage object; querying a data sovereignty policy manager for a data sovereignty policy associated with the data sovereignty policy identifier; obtaining, from the data sovereignty policy manager, an indication of the data sovereignty policy; and storing the object-based storage object in compliance with the data sovereignty policy.

In one example, obtaining the indication of the data sovereignty policy includes: obtaining an indication of a custom data sovereignty policy indicating that a given type of data is to be stored in one or more given geographic regions.

In one example, identifying the data sovereignty policy identifier included in the object-based storage object includes: identifying a data sovereignty policy identifier written to the request by a data sovereignty policy enforcement agent. In a further example, identifying the data sovereignty policy identifier written to the request by the data sovereignty policy enforcement agent includes: identifying the data sovereignty policy identifier written to the request by a data sovereignty policy enforcement agent located within a local user site. In another further example, identifying the data sovereignty policy identifier written to the request by the data sovereignty policy enforcement agent includes: identifying the data sovereignty policy identifier written to the request by a data sovereignty policy enforcement agent located outside a local user site.

In one example, storing the object-based storage object in compliance with the data sovereignty policy includes: storing the object-based storage object with the data sovereignty policy identifier, the method further comprising: based on the data sovereignty policy identifier, performing an audit to determine whether the object-based storage object is stored in compliance with the data sovereignty policy. In a further example, the method further comprises: generating a human-readable report of the audit.

In one example, storing the object-based storage object in compliance with the data sovereignty policy includes: writing the object-based storage object to a cloud point-of-presence permitted by the data sovereignty policy.

In another form, an apparatus is provided. The apparatus comprises: a network interface configured to obtain or provide network communications; and one or more processors coupled to the network interface, wherein the one or more processors are configured to: obtain a request to store an object-based storage object; identify a data sovereignty policy identifier associated with the object-based storage object; query a data sovereignty policy manager for a data sovereignty policy associated with the data sovereignty policy identifier; obtain, from the data sovereignty policy manager, an indication of the data sovereignty policy; and store the object-based storage object in compliance with the data sovereignty policy.

In another form, one or more non-transitory computer readable storage media are provided. The non-transitory computer readable storage media are encoded with instructions that, when executed by a processor, cause the processor to: obtain a request to store an object-based storage object; identify a data sovereignty policy identifier associated with the object-based storage object; query a data sovereignty policy manager for a data sovereignty policy associated with the data sovereignty policy identifier; obtain, from the data sovereignty policy manager, an indication of the data sovereignty policy; and store the object-based storage object in compliance with the data sovereignty policy.

One or more advantages described herein are not meant to suggest that any one of the embodiments described herein necessarily provides all of the described advantages or that all the embodiments of the present disclosure necessarily provide any one of the described advantages. Numerous other changes, substitutions, variations, alterations, and/or modifications may be ascertained to one skilled in the art and it is intended that the present disclosure encompass all such changes, substitutions, variations, alterations, and/or modifications as falling within the scope of the appended claims.

What is claimed is:

1. A computer-implemented method comprising:
obtaining a request to store an object-based storage object;
identifying a data sovereignty policy identifier associated with the object-based storage object;
querying a data sovereignty policy manager for a data sovereignty policy associated with the data sovereignty policy identifier;
obtaining, from the data sovereignty policy manager, an indication of the data sovereignty policy; and
storing the object-based storage object in compliance with the data sovereignty policy.

2. The method of claim 1, wherein obtaining the indication of the data sovereignty policy includes:
obtaining an indication of a custom data sovereignty policy indicating that a given type of data is to be stored in one or more given geographic regions.

3. The method of claim 1, wherein identifying the data sovereignty policy identifier included in the object-based storage object includes:
identifying a data sovereignty policy identifier written to the request by a data sovereignty policy enforcement agent.

4. The method of claim 3, wherein identifying the data sovereignty policy identifier written to the request by the data sovereignty policy enforcement agent includes:
identifying the data sovereignty policy identifier written to the request by a data sovereignty policy enforcement agent located within a local user site.

5. The method of claim 3, wherein identifying the data sovereignty policy identifier written to the request by the data sovereignty policy enforcement agent includes:
identifying the data sovereignty policy identifier written to the request by a data sovereignty policy enforcement agent located outside a local user site.

6. The method of claim 1, wherein storing the object-based storage object in compliance with the data sovereignty policy includes:
storing the object-based storage object with the data sovereignty policy identifier, the method further comprising:
based on the data sovereignty policy identifier, performing an audit to determine whether the object-based storage object is stored in compliance with the data sovereignty policy.

7. The method of claim 6, further comprising:
generating a human-readable report of the audit.

8. The method of claim 1, wherein storing the object-based storage object in compliance with the data sovereignty policy includes:
writing the object-based storage object to a cloud point-of-presence permitted by the data sovereignty policy.

9. An apparatus comprising:
a network interface configured to obtain or provide network communications; and
one or more processors coupled to the network interface, wherein the one or more processors are configured to:
obtain a request to store an object-based storage object;
identify a data sovereignty policy identifier associated with the object-based storage object;
query a data sovereignty policy manager for a data sovereignty policy associated with the data sovereignty policy identifier;
obtain, from the data sovereignty policy manager, an indication of the data sovereignty policy; and
store the object-based storage object in compliance with the data sovereignty policy.

10. The apparatus of claim 9, wherein the one or more processors are configured to:
obtain an indication of a custom data sovereignty policy indicating that a given type of data is to be stored in one or more given geographic regions.

11. The apparatus of claim 9, wherein the one or more processors are configured to:
identify a data sovereignty policy identifier written to the request by a data sovereignty policy enforcement agent.

12. The apparatus of claim 11, wherein the one or more processors are configured to:
identify the data sovereignty policy identifier written to the request by a data sovereignty policy enforcement agent located within a local user site.

13. The apparatus of claim 11, wherein the one or more processors are configured to:
identify the data sovereignty policy identifier written to the request by a data sovereignty policy enforcement agent located outside a local user site.

14. The apparatus of claim 9, wherein the one or more processors are further configured to:
store the object-based storage object with the data sovereignty policy identifier; and
based on the data sovereignty policy identifier, perform an audit to determine whether the object-based storage object is stored in compliance with the data sovereignty policy.

15. The apparatus of claim 14, wherein the one or more processors are further configured to:
generate a human-readable report of the audit.

16. The apparatus of claim 9, wherein the one or more processors are configured to:
write the object-based storage object to a cloud point-of-presence permitted by the data sovereignty policy.

17. One or more non-transitory computer readable storage media encoded with instructions that, when executed by a processor, cause the processor to:
obtain a request to store an object-based storage object;
identify a data sovereignty policy identifier associated with the object-based storage object;
query a data sovereignty policy manager for a data sovereignty policy associated with the data sovereignty policy identifier;
obtain, from the data sovereignty policy manager, an indication of the data sovereignty policy; and
store the object-based storage object in compliance with the data sovereignty policy.

18. The one or more non-transitory computer readable storage media of claim 17, wherein the instructions cause the processor to:
obtain an indication of a custom data sovereignty policy indicating that a given type of data is to be stored in one or more given geographic regions.

19. The one or more non-transitory computer readable storage media of claim 17, wherein the instructions cause the processor to:
identify a data sovereignty policy identifier written to the request by a data sovereignty policy enforcement agent.

20. The one or more non-transitory computer readable storage media of claim 17, wherein the instructions further cause the processor to:
store the object-based storage object with the data sovereignty policy identifier; and
based on the data sovereignty policy identifier, perform an audit to determine whether the object-based storage object is stored in compliance with the data sovereignty policy.
